(19) United States
(12) Patent Application Publication
(10) Pub. No.: US 2010/0036950 A1
(43) Pub. Date: Feb. 11, 2010

(54) METHOD AND APPARATUS FOR PROVIDING HOME CONTENTS

(75) Inventors: Suyoung BAE, Daejeon-city (KR); Changsik CHO, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/483,776

(22) Filed: Jun. 12, 2009

(30) Foreign Application Priority Data
Aug. 7, 2008 (KR) 10-2008-0077623

(51) Int. Cl. G06F 15/173; G06F 7/04

(52) U.S. Cl. 709/225; 726/3

(57) ABSTRACT

The present invention relates to a method and apparatus for providing home contents, which shares contents between contents storage devices within a home network and provides the contents shared on a home network to an external contents sharing device. The present invention shares the contents based on an existing home network middleware in a home network environment that is configured to allow a plurality of contents storage devices to commonly use the same home network middleware, such that the contents information shared within the home network can be shared outside, making it possible to use the contents in the home without regard to time and place.

### RELATED APPLICATIONS

The present application claims priority to Korean Patent Application Serial Number 10-2008-0077623, filed on Aug. 7, 2008, the entirety of which is hereby incorporated by reference.

### BACKGROUND OF THE INVENTION

1. Field of the Invention

The present invention relates to a method and apparatus for providing home contents, and in particular, to a method and apparatus for providing home contents which are capable of sharing home contents on a home network, over an external network.

2. Description of the Related Art

Recently, hot spot areas, which offer a wireless LAN service at various public spaces, such as, a school, an airport lounge, a hotel, etc., on a free or charged fee basis, have rapidly increased. As a result, a lightweight notebook supporting wireless LAN communication and a PMP supporting IP communication have been launched on the market which offers a user a wide bandwidth network services without needing to consider connection places, such as a home, an office, etc. Therefore, various media sharing services, such as contents sharing, place shift TV service, etc., through P2P services between mobile terminals have been introduced.

Efforts to share multimedia contents existing in various digital devices in the home using a standardized program, such as Universal Plug and Play AV (UPNP AV), Digital Living Network Alliance (DLAN), etc. to goods, such as Micro Media Center, have been used.

Meanwhile, various technologies to expand applications of an existing mobile terminal like applications of an existing PC, for example, a wireless mobile environment and a wire/wireless internet, have been developed. However, a support technology to link home networks in a house is still insufficient. Also, development of a service sharing contents in the home outside using a wire/wireless network is delayed due to the lack of availability of a wireless network capable of transmitting and receiving multimedia contents without burden and performance limitations of a terminal with portability.

### SUMMARY OF THE INVENTION

It is an object of the present invention to provide a method and apparatus capable of sharing various multimedia contents, which are shared on a home network, over an external network based on wire/wireless network devices.

To achieve the object of the present invention, there is provided a method for providing home contents shared on a home network to an external contents sharing device according to the present invention comprising the steps of: performing authentication on external devices by sensing connection information on the external devices and comparing the connection information with previously registered connection information when there is a connection request to the contents management device from the external devices over an external network; and providing the contents shared on the home network according to the request of the authenticated external devices and interrupting connection with the external devices when authentication fails at the step of performing the authentication.

To achieve another object of the present invention, there is provided a method for providing home contents shared on a home network to an external contents sharing device over a contents management device according to the present invention comprising the steps of: providing address information on the contents management device from an external management server managing the contents management device information on an external network to the external contents sharing device; requesting a connection to the contents management device based on the address information provided from the external management server; and receiving and performing the contents information shared on the home network and requested contents from a connected contents management device.

To achieve still another object of the present invention, there is provided an apparatus for providing home contents shared on a home network to an external contents sharing device according to the present invention comprising; a communication unit that transmits and receives data to and from an external device connection requested through an external network; a storage unit that stores connection information on the external network corresponding to the home network; and a controlling unit that performs authentication on the external device by sensing connection information on the external device and comparing the connection information with the connection information stored in the storage unit and provides the contents shared on the home network according to the request of the authenticated external device, when there is a connection request from the external device through the communication unit.

The present invention shares the contents based on an existing home network middleware in the home network environment that is configured to allow the plurality of contents storage devices to commonly use the same home network middleware, such that the contents information shared within the home network can be shared outside, making it possible to easily use the contents in the home without regard to time and place.

Further, the present invention protects the external contents sharing device from directly accessing the home network through the contents management device connecting the home network to the external network, which improves security, making it possible to increase reliability against information leaking to the outside, while not allowing the contents sharing device to search the contents in the home network one by one, making it possible to increase operational efficiency.

Furthermore, the present invention can provide the contents shared on the home network to the outside even when a user does not know an IP address and port of a private network or a public network for various devices in the home.

### BRIEF DESCRIPTION OF THE DRAWINGS

FIG. 1 is a system configuration diagram to which an apparatus for providing home contents according to the present invention is applied;

FIG. 2 is a diagram showing one embodiment implemented on a system of FIG. 1;

FIG. 3 is a diagram for explaining a system configuration of FIG. 1; and

FIGS. 4 to 6 are flow charts showing an operational flow of a method for providing home contents according to the present invention.

### DESCRIPTION OF THE PREFERRED EMBODIMENTS

Hereinafter, embodiments of the present invention will be described with reference to the accompanying drawings.

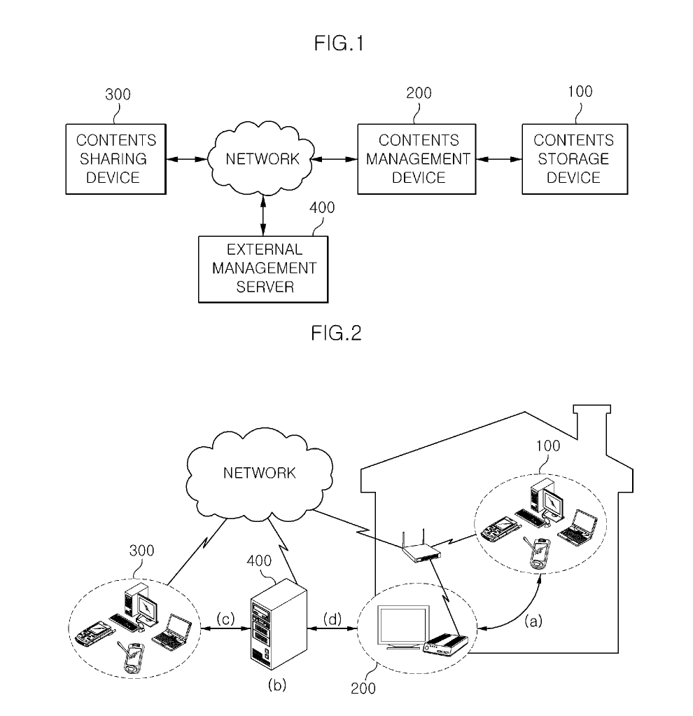

FIG. 1 is a system configuration diagram for explaining a system configuration for providing home contents including an apparatus for providing home contents according to one embodiment of the present invention, and FIG. 2 is a view for illustrating an operation of a system for providing home contents of FIG. 1.

Referring to FIGS. 1 and 2, a system for providing home contents includes a contents storage device 100, a contents management device 200, a contents sharing device 300, and an external management server 400.

The contents storage device 100 is a storage device located in the home and storing at least one contents. As the contents storage device 100, a PC, a notebook, a PMP, a camera, an MP3 player, etc. may be used. At this time, the contents storage device 100 supports a communication protocol using a home network middleware, such as Jini, sun, Lonworks, HAVi (Home Audio Video Interoperability), UPnP AV (Universal Plug and Play AV), etc.

The home network may be a private network or a public network that is established by a communication service company or a person. The embodiment of the present invention will be described, by way of example, based on a case where the home network is the private network. At this time, at least one contents storage device 100 is connected to the home network using a private IP allocated to the corresponding private network.

As a result, the content storage device 100 is connected to the home network using the communication protocol, such that it can share predetermined contents with other contents storage devices 100 in the home. In other words, when the contents storage device 100 receives a predetermined contents request from other contents storage devices 100 connected to the home network, it provides the requested contents. Likewise, the contents storage device 100 requests predetermined contents stored in the other contents storage device 100, such that it receives predetermined contents from the other contents storage devices 100.

The contents storage device 100 is linked to the contents management device 200 within the home network to transmit predetermined contents to the contents management device 200 or receive predetermined contents from the contents management device 200. When the contents storage device 100 transmits the requested contents to the other contents storage device 100 or the contents management device 200, it transmits the requested contents in a streaming scheme or a download scheme.

The contents management device 200 is connected to the home network, such that it can be linked to at least one contents storage device 100 connected to the home network. At this time, the contents management device 200 supports the communication protocol using the home network middleware, such as Jini, sun, Lonworks, HAVi, UPnp AV, etc., likewise the contents storage device 100. This will be described with reference to FIG. 2(a).

Meanwhile, the contents management device 200 includes a module that supports communication with an external network. In other words, the contents management device 200 can be connected to the home network as well as the external network. The external network, which is a different public network from the home network, transmits and receives data using a public IP allocated to the public network.

The contents management device 200 can be connected to the external management server 400 through the external network. The external management server 400, which is a server managing address information for connecting to the contents management device 200 connected to the home network, is registered with a public IP address corresponding to a private IP address of the home network and port information of the public IP. In other words, when the contents management device 200 is connected to the external management server 400, it confirms the connected public IP address information and the port information and registers the confirmed information along with a user ID of the contents management device 200 in the external management server 400.

The external management server 400 is connected to the contents management device 200 and the contents sharing device 300, respectively, through the external network to transmit and receive predetermined data.

At this time, the external management server 400 receives connection information, such as the public IP address and the port information from the contents management device 200 and registers the information. When the address information on the contents management device 200 is requested from the contents sharing device 300, the external management server 400 performs a authentication on the contents sharing device 300 and then provides the address information on the contents management device 200 to the authenticated contents sharing device 300.

The contents sharing device 300 is a terminal supporting IP communication with a wire/wireless network, such as an external local area network (LAN), a wireless LAN (WLAN), a code division multiple access (CDMA), a high speed downlink packet access (HSDPA), a wireless internet platform for interoperability (Wibro), etc. As the contents sharing device 300, at least one of a mobile terminal, a PC, a notebook, a portable multimedia player (PMP), a personal digital assistance (PDA), and an MPEG audio layer-3 player (MP3P) may be used.

The contents sharing device 300 is connected to the external management server 400 for connecting to the contents management device 200 in the home to request the address information on the contents management device 200. At this time, the contents sharing device 300 attempts connection to the contents management device 200 using the address information on the contents management device 200 provided from the external management server 400, that is, the public IP address information that corresponds to the private IP of the home network.

At this time, the contents sharing device 300 can be connected to the contents management device 200 in two ways according to the internal environment of the contents management device 200. This can be confirmed through the embodiment of FIG. 2. One way may include a case (b) where the contents sharing device 300 is directly connected to the contents management device 200. Another way may include cases (c and d) where the contents sharing device 300 is indirectly connected to the contents management device 200 through the external management server 400.

First, as in case (b) where the contents sharing device 300 is directly connected to the contents management device 200, if the contents management device 200 receives the connection request from the contents sharing device 300, after authentication is performed on the contents sharing device 300 requesting connection, the contents sharing device 200 provides the predetermined contents shared within the home network according to the request of the contents sharing device 200.

Accordingly, the contents sharing device 300 receives the predetermined contents stored in at least one contents storage device 100 located in the home through the contents management device 200.

Meanwhile, in cases (c and d) where the contents sharing device 300 is indirectly connected to the contents management device 200 through the external management server 400, may include the case where the contents management device 200 allows connection only for the external management server 400 initially connected thereto and does not allow connection for the contents sharing device 300, even though the contents sharing device 300 is connected to the private IP of the home network through the connectable public IP as shown in FIG. 2(b).

In this case, the contents sharing device 300 can be connected to the contents management device 200 through the external management server 400. In other words, the contents sharing device 300 requests to the external management server 400 to be connect to the contents management device 200, and the external management server 400 attempts the connection to the contents management device 200 using the address information on the registered contents management device 200. At this time, after the contents management device 200 performs the authentication on the external management server 400, it provides the predetermined contents shared within the home network to the external management server 400.

The external management server 400 performs a role of transferring the contents transmitted and received between the contents management device 200 and the contents sharing device 300 according to the request of the contents sharing device 300. Therefore, the contents sharing device 300 requests the contents shared within the home network through the external management server 400 and receives the requested contents from the external management server 400.

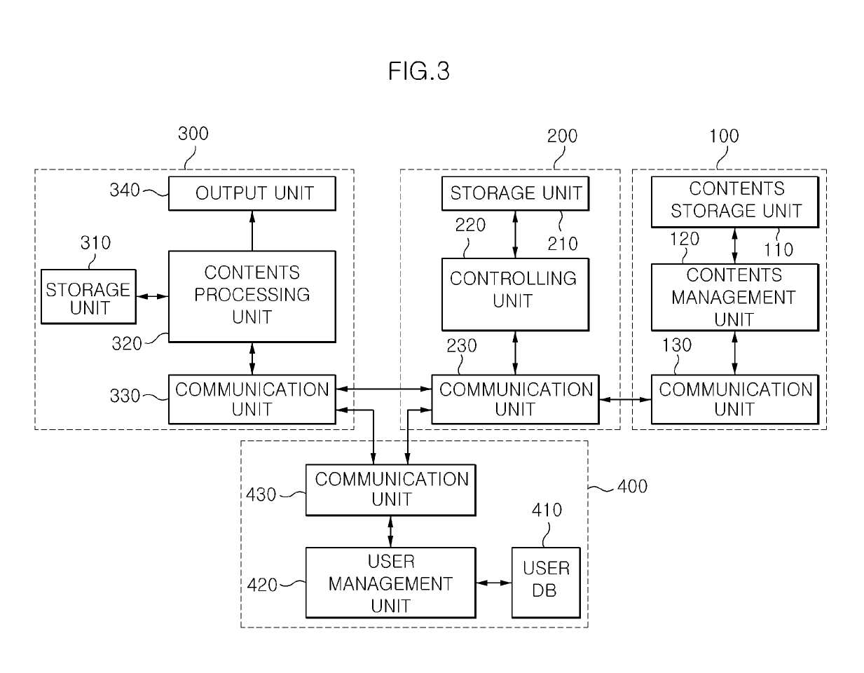

FIG. 3 refers to a block configuration view to explain a configuration of the system for providing the home contents.

Referring to FIG. 3, the contents storage device 100 includes a contents storage unit 110, a contents management unit 120, and a communication unit 130.

The contents storage unit 110 stores contents and detailed information on the contents. The detailed information on the contents includes at least one of a kind of contents, a file name, a size, a file format, a compression format, contents reproduction information. Also, the contents storage unit 110 stores a contents list on the contents.

The contents management unit 120 provides the contents stored in the contents storage unit 110 according to the request of the other contents storage devices in the home and the contents management unit 200. The communication unit 120 provides an interface for home network connection and includes the module for communication, such as UPnp AV, etc.

The contents management device 200 includes a controlling unit 220 that controls the transmission and reception of the contents stored in at least one contents storage device 100 located in the home and a communication unit 230 for communicating with the contents storage device 100. The contents management device 200 further includes a storage unit 210 in which the contents information shared within the home network is stored.

The communication unit 230 provides an interface for communicating between the home network and the external network. At this time, the module for the home network connection and the module for the external network connection may be provided separately. The module for the home network connection transmits and receives data to and from each contents storage device 100 using the private IP allocated to the home network. Meanwhile, the module for the external network connection can be connected to the contents sharing device 300 using the public IP information obtained by connecting with the external management server 400 according to the internal environment. At this time, the module for connecting the external network can be connected to the contents sharing device 300 using the public IP information obtained through connection with the external management server 400 according to the internal environment.

The controlling unit 220 controls the transmission and reception of contents between the contents storage device 100 in the home network and the contents sharing device 300 in the external network.

Therefore, when the controlling unit 220 receives the contents request from the contents sharing device 300, it directly searches at least one contents stored in the contents storage device 100 in the home network and transmits the searched contents to the contents sharing device 300 in the external network. At this time, the controlling unit 220 converts the corresponding contents into packets, which are then transmitted to the external network.

The contents sharing device 300 includes a storage unit 310, a contents processing unit 320, a communication unit 330, and an output unit 340.

The storage unit 310 stores the contents list received from the contents management device 200 in the home network. The storage unit 310 stores the contents provided from the contents management device 200.

The communication unit 330 includes the module providing the interface for communication connection with the contents management device 200 and the external management server 400.

The contents processing unit 320 is connected to the external management server 400 through the communication unit 300 to request the address information on the contents management device 200. At this time, the contents processing unit 320 requests connection to the contents management device 200 based on the address information on the contents management device 200 and requests the predetermined contents list when the contents processing unit 320 is connected to the contents management device. Further, the contents processing unit 320 requests any one contents from the contents list received from the contents management device 200 and executes the contents provided from the contents management device 200 to be output by the output unit 340.

At this time, the contents provided from the contents management device 200 or the external management server 400 are provided by a streaming scheme or a download scheme and some downloaded contents are stored in the storage unit 310.

The output unit 340, which is a unit outputting the predetermined contents, includes a display outputting a video signal and a speaker outputting an audio signal. Therefore, when the predetermined contents are executed through the contents processing unit 320, the output unit 340 outputs the video signal and the sound signal through the display and the speaker, etc. The output unit 340 can further include a further signal output unit.

The external management server 400 includes a user management unit 420 that manages the address information received from the contents management device 200 and the user information corresponding to the address information and a communication unit 430 that includes a module providing the interface for communication with the contents management device 200 and the contents sharing device 300 through the external network. Also, the external management server 400 further includes a user DB 410 storing the address information and the user information on the connected contents management device.

At this time, the communication unit 430 obtains the public IP address information corresponding to the private IP address allocated to the home network of the contents management device 200 and is connected to the contents management unit 200 through the external network using the obtained information.

Meanwhile, the user management unit 420 registers and manages the user ID and the port information of the contents management device 200 along with the public IP address corresponding to the private IP address of the contents management device 200, such that it provides the address information of the corresponding contents management device 220 to the contents sharing device 300 or directly transmits and receives the contents to the contents management device 200.

At this time, when the user management unit 420 receives the connection request from the contents sharing device 300 to the contents management device 200, it performs authentication on the user of the contents sharing device 300 to transmit the contents between the contents management device 200 and the contents sharing device 300.

An operation of the present invention configured as above will be described below.

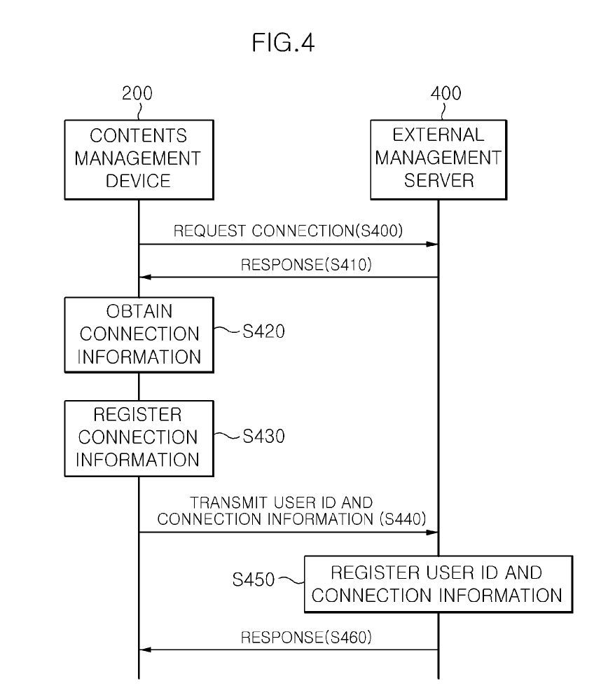

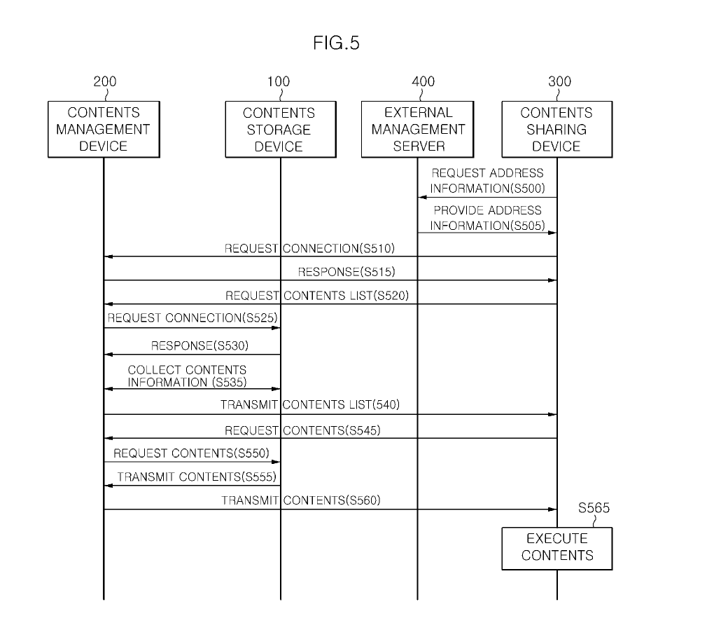

FIGS. 4 and 5 are flow charts showing an operational flow of the system for providing the home contents according to the present invention.

First, FIG. 4 shows a process of obtaining the address information on the external network corresponding to the home network according to the present invention. Referring to FIG. 4, the contents management device 200 requests connection to the external management server 400 so as to obtain the information connected to the external management server 400 (S400). At this time, the external management server 400 responds to the connection request of the contents management device 200 (S410), such that the contents management device 200 and the external management server 400 are connected to each other.

When the contents management device 200 is connected to the external management server 400, it obtains the connection information on the external network connected to the external management server 400, that is, the public IP address and the port information (S420) and registers the obtained connection information (S430). The contents management device 200 stores the connection information as well as identification information on the connected external management server 400.

The contents management device 200 transmits the user information on the contents management device 200 and the obtained connection information to the external management server 400 (S440).

The external management server 400 registers the connection information received from the contents management device 200 and the corresponding user information (S450) and transmits the response signal to the contents management device 200 (S460). At this time, the external management server 400 manages the information on the registered contents management device 200.

FIG. 5 shows an operational flow of the method for providing the home contents according to one embodiment of the present invention. Referring to FIG. 5, the contents sharing device 300 requests the address information on the contents management device 200 to the external management server 400, such that it is connected to the contents management device 200 providing the contents shared in the home network (S500). At this time, the external management server 400 detects the address information on the corresponding contents management device 200 and transmits the detected address information to the contents sharing device 300 (S505). The external management server 400 performs the predetermined authentication procedure on the contents sharing device 300 requesting the address information on the contents management device 200 and then provides the detected address information. Optionally, the authentication procedure can be omitted.

The contents sharing device 300 requests connection to the contents management device 200 based on the address information received from the external management server 400 (S510) and the contents management device 200 responds to the request, such that they are connected to each other (S515). Of course, the contents management device 200 confirms whether the contents sharing device 300 requesting connection is a previously registered contents sharing device 300, performs the authentication procedure on the contents sharing device 300, and then allows connection of the contents sharing device 300. Likewise, the authentication procedure can also be omitted.

The contents sharing device 300 requests the contents list shared within the home network to the connected contents management device 200 (S520). At this time, the contents management device 200 requests connection to the contents storage device 100 within the home network (S525) and at least one contents storage device 100 responds to the connection request, such that it is connected to the home network (S530).

Further, the contents management device 200 searches at least one contents storage device 100 connected and collects at least one contents information (S535) and transmits the contents list generated based on the collected contents information to the contents sharing device 300 (S540). At this time, the contents sharing device 300 receives the contents list form the contents management device 200 and requests the corresponding contents to the contents management device 200 when any one of the received contents lists is selected (S545).

The contents management device 200 requests the contents to the corresponding contents storage device 100 (S550). At this time, the contents storage device 100 receiving the contents request from the contents management device 200 detects the corresponding contents and transmits the detected contents in the streaming scheme or the download scheme (S555). The contents management device 200 transmits the contents provided from the contents storage device 100 to the contents sharing device 300 (S560), such that the contents sharing device 300 executes the transmitted contents externally (S565).

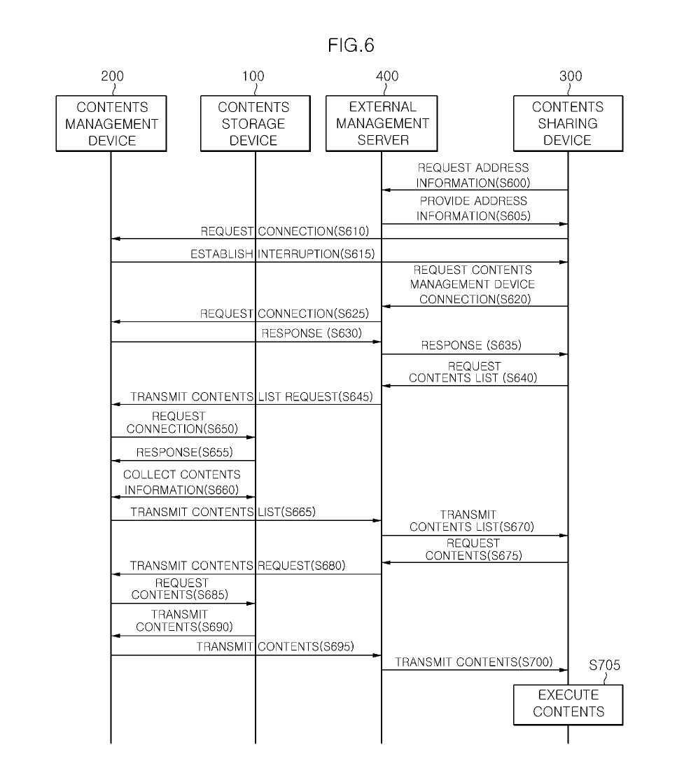

FIG. 6 shows an operation flow of the method for providing the home contents according to another embodiment of the present invention. The embodiment of FIG. 6 shows a case where the connection request of ‘S510’ process performing the embodiment of FIG. 5 is interrupted. When the contents sharing device 300 attempts to access IPs other than the public IP corresponding to the private IP or there is an access attempt from devices other than the initially connected external management server 400, the contents management device 200 can interrupt the access.

Referring to FIG. 6, the contents sharing device 300 requests the address information on the contents management device 200 to the external management server 400 such that it is connected to the contents management device 200 providing the contents shared within the home network (S600). At this time, the external management server 400 detects the address information on the corresponding contents management device 200 and transmits the detected address information to the contents sharing device (S605). The external management server 400 performs the predetermined authentication procedure on the contents sharing device 300 requesting the address information on the contents management device 200 and then provides the detected address information to the corresponding contents sharing device 300. Of course, the authentication procedure can be omitted.

The contents sharing device 300 requests the connection to the contents management device 200 based on the address information received from the external management server 400 (S610). At this time, the contents management device 200 confirms whether the contents sharing device 300 requesting the connection is a previously registered device. In other words, at step ‘S430’, of FIG. 4 it confirms whether the registered address information and the identification information on the external management server 400 corresponds with the information on the contents sharing device 300 requesting the connection by comparing their information. If not corresponded, the contents management device 200 interrupts the connection of the contents sharing device 300 requesting the connection and informs the corresponding contents sharing device 300 of the connection interruption to the corresponding contents sharing device 300 (S615).

When the connection is interrupted from the contents management device 200, the contents sharing device 300 is back connected to the external management server 400 to request the connection to the contents management device 200 (S620). At this time, the external management server 400 requests connection to the corresponding contents management device 200 according to the request of the contents sharing device 300 (S625). The contents sharing device 300 is a device performing the authentication procedure in the external management server 400. On the other hand, the contents management device 200 responds to the connection request of the external management server 400 (S630) and the external management server 400 responds to the connection request of the contents sharing device 300 again (S635). Of course, the contents management device 200 can perform the predetermined authentication procedure on the external management server 400 requesting connection and then respond to the connection.

Therefore, the contents sharing device 300 transmits the signal requesting the contents list shared within the home network to the external management server 400 (S640) and the external management server 400 transmits the signal requesting the contents sharing device 300 to the contents management device 200 (S645). At this time, the contents management device 200 requests connection to the contents storage device 100 within the home network (S650) and the contents storage device 100 within the home network responds to the connection request, such that it is linked to at least one contents management device 100 (S655). Also, the contents management device 200 searches at least one linked contents storage device 100 to collect the contents information and transmits the contents list generated based on the collected contents information to the external management server 400 (S665). At this time, the external management server 400 transmits the received contents list to the contents sharing device 300 (S670).

On the other hand, when any one of the contents lists received from the external management server 400 is selected, the contents sharing device 300 transmits the signal requesting the selected contents to the external management server 400 (S675). The external management server 400 transmits the received request signal to the contents management device 200 (S680). At this time, the contents management device 200 confirms the contents requested from the external management server 400 and requests the confirmed contents to the corresponding contents storage device (S685).

The contents storage device 100 receiving the contents request from the contents management device 200 detects the corresponding contents and transmits the detected contents to the contents management device 200 in the streaming scheme and the download scheme (S690). The contents management device 200 transmits the contents provided from the contents storage device 100 to the external management server 400 (S695), and the external management server 400 transmits the contents to the contents sharing device 300 (S700), such that the contents sharing device 300 externally executes the contents transmitted from the external management server 400 (S705).

As described above, although the method and apparatus for providing the home contents according to the present invention are described with reference to the illustrated drawings, the present invention is not limited to the disclosed embodiment and the drawings, but the technical idea of the present invention can be applied within the protective scope of the present invention.

1. A method for providing contents shared on a home network to an external contents sharing device comprising:
performing authentication on external devices by sensing connection information on the external devices and comparing the connection information with previously registered connection information when there is a connection request to the contents management device from the external devices over an external network; and
providing the contents shared on the home network according to the request of the authenticated external devices and interruption connection with the external devices when authentication fails the performing authentication.

2. The method of claim 1, wherein the external device is one of an external management server that manages the contents management device information between the contents management device and the contents sharing device and the contents sharing device.

3. The method of claim 1, wherein the of performing authentication the connection information includes at least one of a device information connectable to the contents management device, IP address and connection port information of the external network corresponding to the connection IP of the home network.

4. The method of claim 1, wherein the performing the authentication confirms whether the connection IP address information of the external device corresponds with a previously registered connection IP and permits or intercepts connection of the external device according to the result of the confirmation.

5. The method of claim 4, wherein the performing authentication permits or interrupts connection of the external device by determining whether the external device is the previously registered device when the connection IP addresses information on the external device corresponds with the previously registered connection IP address.

6. The method of claim 1, further comprising collecting the contents information shared within the home network and provides the collected contents information to the authenticated external device, prior to the providing the contents.

7. The method of claim 1, wherein the providing the contents, the contents are provided from the corresponding contents storage device in a streaming scheme or a download scheme.

8. A method for providing contents shared on a home network to an external contents sharing device over a contents management device comprising:
receiving address information on the contents management device from an external management server managing the contents management device information on an external network;
requesting a connection to the contents management device based on the address information provided from the external management server; and
receiving and performing the contents information shared on the home network and requested contents from the connected contents management device.

9. The method of claim 8, wherein the address information on the contents management device is IP address information of the external network corresponding to the connection IP of the home network.

10. The method of claim 8, further comprising after the requesting connection, retrying connection to the contents management device through the external management server when connection is interrupted from the contents management device,
the contents shared on the home network through the external management server being provided and executed.

11. An apparatus for providing contents shared on a home network to an external contents sharing device comprising;
a communication unit that transmits and receives data to and from an external device requesting connection through an external network;
a storage unit that stores connection information on the external network corresponding to the home network; and
a controlling unit that performs authentication on the external device by sensing connection information on the external device and comparing the connection information with the connection information stored in the storage unit and provides the contents shared on the home network according to the request of the authenticated external device, when there is a connection request from the external device through the communication unit.

12. The apparatus of claim 11, wherein the external device is one of an external management server that manages the contents management device information between the contents management device and the contents sharing device, and the contents sharing device.

13. The apparatus of claim 11, wherein the connection information includes at least one of a device information connectable to the contents management device, IP address and connection port information of the external network corresponding to the connection IP of the home network.

14. The apparatus of claim 11, wherein the controlling unit confirms whether the connection IP address information of the external device corresponds with a previously registered connection IP and permits or intercepts connection of the external device according to a result of the confirmation.

15. The apparatus of claim 14, wherein the controlling unit permits or interrupts connection of the external device by determining whether the external device is the previously registered device when the connection IP addresses information on the external device corresponds with the previously registered connection IP address.

16. The apparatus of claim 11, wherein the controller collects the contents information shared within the home network and provides the collected contents information to the authenticated external device.

17. The apparatus of claim 11, wherein the controller searches the contents storage device in which the requested contents are stored within the home network and receives the requested contents from the corresponding contents storage device in a streaming scheme or a download scheme when there is a contents request from the external device.
